(19) United States
(12) Patent Application Publication
(10) Pub. No.: US 2018/0287227 A1
(43) Pub. Date: Oct. 4, 2018

(54) BATTERY PACK FOR VEHICLE, AND VEHICLE

(71) Applicant: LG ELECTRONICS INC., Seoul (KR)

(72) Inventors: Sunhee JEONG, Seoul (KR); Sangyun LEE, Seoul (KR); Junguk HWANG, Seoul (KR)

(21) Appl. No.: 15/857,697

(22) Filed: Dec. 29, 2017

(30) Foreign Application Priority Data
Mar. 30, 2017 (KR) 10-2017-0041044

(51) Int. Cl. H01M 10/617; H01M 10/625; B60K 1/04; B60L 11/18; H01M 2/10

(52) U.S. Cl. CPC H01M 10/617; H01M 10/625; B60K 1/04; B60L 11/1877; H01M 2/024; H01M 2/1094; B60L 11/1872; B60Y 2200/91; B60L 11/1879

(57) ABSTRACT

A battery pack for a vehicle includes at least one battery module; and a thermal management system disposed below the at least one battery module and configured to cool the at least one battery module with a liquid coolant. The thermal management system includes: an upper plate that is composed of a steel material having a corrosion preventive layer on a surface thereof, and that is configured to support the at least one battery module on a first side of the upper plate; and a lower plate that is composed of a steel material having a corrosion protection layer on a surface thereof, the lower plate arranged at a second side of the upper plate opposite the first side, and together with the upper plate forms a passage therebetween configured to provide circulation of the liquid coolant.

### CROSS-REFERENCE TO RELATED APPLICATION

This application claims the benefit of an earlier filing date and right of priority to Korean Patent Application No. 10-2017-0041044, filed on Mar. 30, 2017 in the Korean Intellectual Property Office, the disclosure of which is incorporated herein by reference.

### TECHNICAL FIELD

The present disclosure relates to a battery pack for vehicle, and a vehicle.

### BACKGROUND

A vehicle is an apparatus that moves in a direction desired by a user riding therein. A representative example of a vehicle is an automobile.

Electric or hybrid vehicles that are powered by electrical energy have attracted growing attention. A vehicle using electrical energy typically includes a battery pack that provides the electrical energy.

### SUMMARY

Implementations are disclosed herein that provide a thermal management system for a battery pack of a vehicle.

In one aspect, a battery pack for a vehicle includes at least one battery module; and a thermal management system disposed below the at least one battery module and configured to cool the at least one battery module with a liquid coolant. The thermal management system includes: an upper plate that is composed of a steel material having a corrosion preventive layer on a surface thereof, and that is configured to support the at least one battery module on a first side of the upper plate; and a lower plate that is composed of a steel material having a corrosion protection layer on a surface thereof, the lower plate arranged at a second side of the upper plate opposite the first side, and together with the upper plate forms a passage therebetween configured to provide circulation of the liquid coolant.

In some implementations, the lower plate and the upper plate are bonded together to form the passage therebetween that is configured to prevent leakage of the liquid coolant to an outside of the thermal management system.

In some implementations, the lower plate includes: a passage portion forming a passage shape through which the liquid coolant flows; and a bonding portion that is bonded to the upper plate and that includes a blocking portion that protrudes toward the upper plate to maintain an integrity of an adhesive that bonds the upper plate and the lower plate.

In some implementations, the upper plate includes a protruding portion that is formed in an area corresponding to the bonding portion, and that protrudes toward the bonding portion to block leakage of the adhesive that bonds the upper plate and the lower plate.

In some implementations, at least part of the bonding portion is configured to support the at least one battery module.

In some implementations, the bonding portion includes: an opening portion configured to allow leakage of an adhesive that bonds the upper plate and the lower plate; and a seal cap disposed below the opening portion to form a space for accommodating a leaked adhesive.

In some implementations, a bottom surface of the passage portion is formed to have a first gradient in a first direction with respect to the upper plate.

In some implementations, the passage portion includes a coolant discharge hole which is formed at the bottom surface, and that is configured to open and close in response to an electrical signal.

In some implementations, the passage portion includes a first notch portion formed on a surface facing the upper plate.

In some implementations, the passage portion includes a second notch portion formed on a surface opposing the upper plate.

In some implementations, the lower plate has a thickness that is less than a thickness of the upper plate.

In some implementations, the battery pack further includes a reinforcement structure that is formed outside the at least one battery module, and which has one or more closed spaces therein.

In some implementations, the battery pack further includes an extension plate in contact with at least part of the lower plate, and the lower plate is bolted to the reinforcement structure and the extension plate.

In some implementations, the lower plate has a length that is greater than a length of the upper plate in a direction outward from the at least one battery module.

In some implementations, the reinforcement structure is configured to be secured to a body of the vehicle and to the thermal management system.

In some implementations, the battery pack further includes an outer plate that is disposed below the thermal management system, bolted to the upper plate, and coupled to a body of the vehicle via a reinforcement beam to thereby support the at least one battery module and the thermal management system.

In some implementations, the upper plate is coupled to a lateral housing of the at least one battery module and is configured as a housing of the at least one battery module.

In some implementations, the lower plate and the upper plate are configured to form the passage therebetween to maintain the circulation of the liquid coolant outside the at least one battery module.

In some implementations, the thermal management system is configured to, upon physical impact on the battery pack, release at least part of the liquid coolant to an outside of the battery pack.

In another aspect, a vehicle includes a plurality of wheels; a power source configured to drive a rotation of at least one of the plurality of wheels; and a battery pack. The battery pack includes: at least one battery module; and a thermal management system disposed below the at least one battery module and configured to cool the at least one battery module with a liquid coolant. The thermal management system includes: an upper plate that is composed of a steel material having a corrosion preventive layer on a surface thereof, and that is configured to support the at least one battery module on a first side of the upper plate; and a lower plate that is composed of a steel material having a corrosion protection layer on a surface thereof, the lower plate arranged at a second side of the upper plate opposite the first side, and together with the upper plate forms a passage therebetween configured to provide circulation of the liquid coolant.

The details of one or more implementations are set forth in the accompanying drawings and the description below. Other features will be apparent from the description and drawings, and from the claims. The description and specific examples below are given by way of illustration only, and various changes and modifications will be apparent.

### BRIEF DESCRIPTION OF THE DRAWINGS

FIG. 1 is a diagram illustrating an example of an exploded perspective view of a battery pack for vehicle according to an implementation;

FIG. 2 is a diagram illustrating an example of a perspective view of a battery pack, from which a battery module is removed, according to an implementation;

FIG. 3 is a diagram illustrating an example of a cross-sectional view, taken along line A-A shown in FIG. 2, according to an implementation;

FIG. 4 is a diagram illustrating an example of a partial cross-sectional view of a battery pack according to an implementation;

FIG. 5 is a diagram illustrating an example of a configuration of a thermal management system according to an implementation, and is an enlarged view of a portion B shown in FIG. 3;

FIG. 6 is a diagram illustrating an example of a bonding between an upper plate and a lower plate according to an implementation;

FIG. 7 is a diagram illustrating an example of an opening portion and a seal cap in a thermal management system according to an implementation;

FIGS. 8 and 9 are diagrams illustrating examples of a blocking portion and a protrusion in a thermal management system according to an implementation;

FIG. 10 is a diagram illustrating an example of a passage portion in a thermal management system according to an implementation;

FIGS. 11 to 13 are diagrams illustrating examples of a notch portion in a thermal management system according to an implementation;

FIG. 14 is a diagram illustrating an example of an enlarged view of a portion C shown in FIG. 3;

FIG. 15 is a diagram illustrating an example of an enlarged view of a portion E shown in FIG. 14;

FIG. 16 is a diagram illustrating an example of an enlarged view of a portion D shown in FIG. 14;

FIG. 17 is a diagram illustrating an example of an enlarged view of a portion F shown in FIG. 3; and

FIGS. 18 and 19 are diagrams illustrating examples of an outer plate of a thermal management system according to an implementation.

### DETAILED DESCRIPTION

In some implementations, to obtain high power output, a battery pack may include a battery module formed of a set of connected cell assemblies having a plurality of unit battery cells. Each unit battery cell may include positive and negative electrode collectors, a separator, active materials, and electrolyte, so that repeated charging and discharging can be done by electrochemical reaction between the components.

In some implementations, a battery pack may further include a Battery Management system (BMS). The BMS may monitor and control a state of a secondary cell by applying various algorithms, such as algorithms for controlling power in response to dynamic load (e.g., in a motor), algorithms for measuring an electrical feature value (e.g., current or voltage), algorithms for controlling equalization of voltage, and/or algorithms for estimating a State of Charge (SOC).

A battery pack including at least one battery module may be manufactured such that a plurality of secondary cells, or battery cells, are densely packed in a small space. In such implementations, a battery pack typically implements a thermal management system for dissipating heat that is generated by each secondary cell in the densely-packed cluster of secondary cells. In order to cool down heat generated by the battery module, the thermal management system may have an air-cooling or liquid-cooling coolant passage, which may be embedded in a battery module.

However, in the scenario of a battery pack having a liquid-cooling thermal management system, a breakage of the passage may result in leakage of the coolant, potentially causing a short-circuit within the battery pack. Such scenarios may occur, for example, upon a physical impact on the battery pack, such as during an accident or when shock is applied to the vehicle and/or battery pack.

Implementations disclosed herein address the above challenges and risks by providing a vehicle battery pack that is configured to spatially separate a thermal management system from a battery module, so as to help prevent a short-circuit from occurring due to leakage of coolant from the thermal management system.

In some scenarios, implementations described herein may have one or more effects as follows.

First, spatially separating the battery module and the thermal management system from each other may help prevent dielectric breakdown caused by possible leakage of coolant.

Second, implementations may include a structure designed to prevent coolant from flowing into a battery module upon an external impact, thereby mitigating a secondary damage caused by a short-circuit of an electronic component.

Third, an integrated housing may be provided for the thermal management system and the battery module, thus reducing the number of components needed and reducing manufacturing costs.

Effects of the present disclosure are not limited to the aforementioned effects and other unmentioned effects will be clearly understood by those skilled in the art from the claims.

A vehicle as described in this specification may include any suitable motorized vehicle, such as an automobile and a motorcycle. Hereinafter, a description will be given based on an automobile.

A vehicle as described in this specification may be powered by any suitable source of power, and may include all of an internal combustion engine vehicle including an engine as a power source, a hybrid vehicle including both an engine and an electric motor as a power source, and an electric vehicle including an electric motor as a power source.

In the following description, a “forward direction” may be defined as a forward direction of travel of a vehicle. A “backward direction” may be defined as a backward direction of travel of a vehicle.

The term “left side” may be defined as the left side in the forward direction of travel of a vehicle. The term “right side” may be defined as the right side in the forward direction of travel of a vehicle.

The term “top” may be defined as an opposite direction of gravity. The term “above” may be defined as a direction toward the top. The term “bottom” may be defined as a direction of gravity. The term “below” may be defined as a direction toward the bottom.

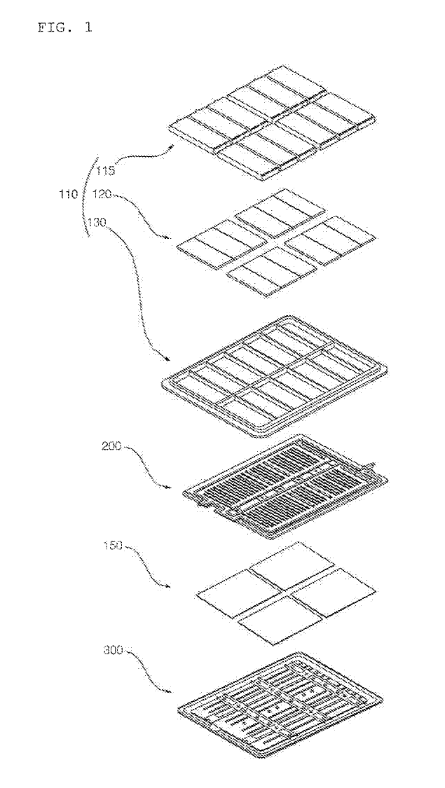

FIG. 1 is an exploded perspective view of a battery pack for vehicle according to an implementation.

A vehicle according to an implementation may include a battery pack 100 for vehicle.

Referring to FIG. 1, the battery pack 100 may include at least one battery module 110, a thermal management system 200, and an outer plate 300.

The battery module 110 may include a battery cell stack 115, and a cartridge 130.

The battery cell stack 115 may include a plurality of battery cells. Each unit battery cell may constitute a secondary cell.

The battery cell stack 115 may include a plurality of battery cell assemblies which is a plurality of multiple battery cells stacked in a horizontal or vertical direction.

Each battery cell may include positive and negative electrode current collectors, a separator, active materials, and electrolyte, so that repeated charging and discharging can be done by electrochemical reaction between the components.

The cartridge 130 is a structure configured for stacking a plurality of battery cells. By holding the plurality of battery cells, the cartridge 130 may prevent movement of the plurality of battery cells. In addition, the cartridge 130 is configured to allow the plurality of battery cells to be stacked, and thus, the cartridge 130 may guide assembling of the plurality of battery cells.

The cartridge 130 may include a plurality of rectangle rings each having a blank area on the center thereof.

As illustrated in FIG. 1, the cartridge 130 may be disposed below the battery cell stack 115.

In some implementations, the cartridge 130 may be an element included in the battery cell stack 115.

The battery module 110 may further include a thermal pad 120 disposed between the battery cell stack 115 and the cartridge 130.

The thermal pad 120 is used as a medium for transferring heat, generated by the battery cell stack 115, to the outside. The thermal pad 120 is formed of a material having high thermal conductivity.

The thermal pad 120 may be disposed between the battery cell stack 115 and the thermal management system 200. In this case, the thermal pad 120 may transfer heat, generated by the batty cell stack 115, to the thermal management system 200.

The thermal management system 200 may cool down heat generated by the battery module 110.

In some implementations, the thermal management system 200 may be disposed below the battery module 110 to support the battery module 110. The thermal management system 200 may be disposed below the battery module 110 and in contact with the battery module 110. In general, the thermal management system 200, or parts thereof, may be disposed outside the battery module 110, for example along the sides or on top of the battery module 110, so as to spatially separate the liquid coolant from the battery module.

The thermal management system 200 will be described in detail with references to FIGS. 1 to 13.

In these examples, the outer plate 300 is disposed below the thermal management system 200. The outer plate 300 may cover the battery back pack 100 attached to a vehicle.

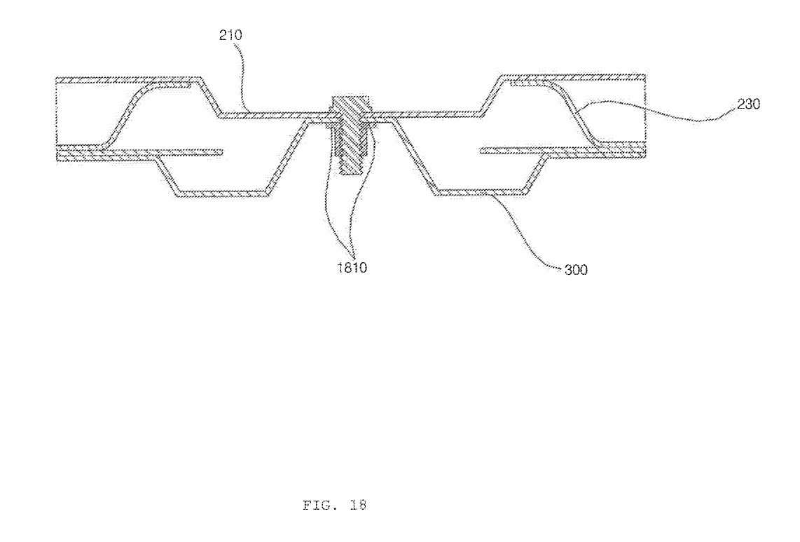

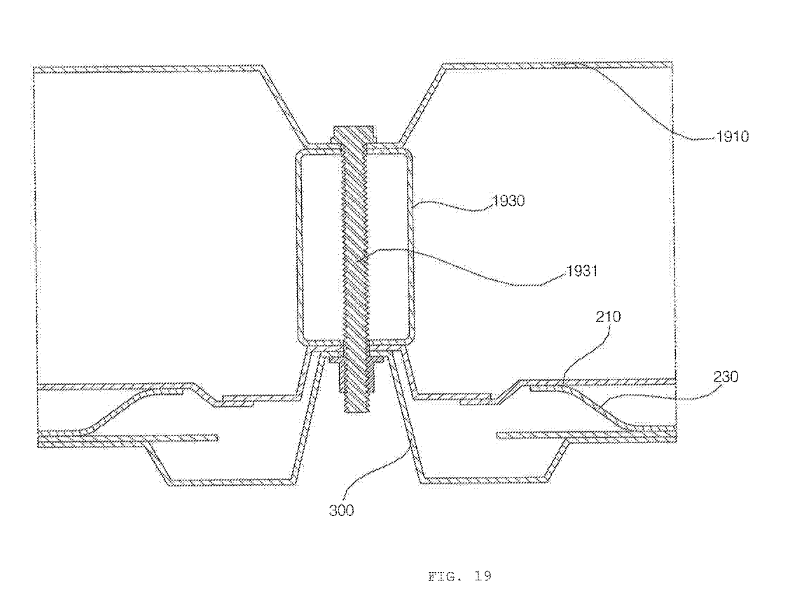

The outer plate 300 will be described in more detail with references to FIGS. 18 and 19.

In some implementations, the battery back 100 may further include an insulation pad 150.

The insulation pad 150 may be disposed between the thermal management system 200 and the outer plate 300. The insulation pad 150 may block heat transferred from the outside to the inside of the battery pack 100.

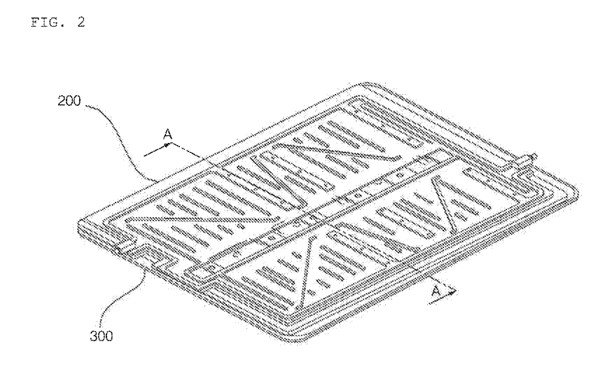

FIG. 2 is a perspective view of a battery pack, from which a battery module is removed, according to an implementation.

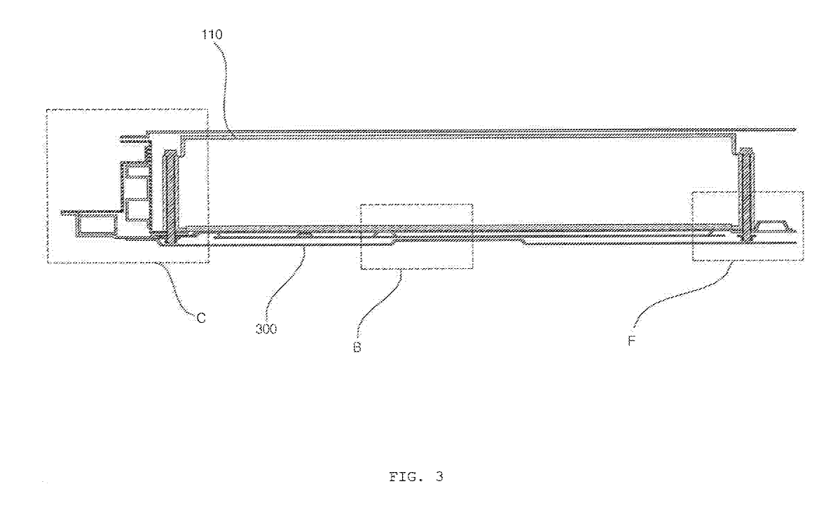

FIG. 3 is a cross-sectional view, taken along line A-A shown in FIG. 2, according to an implementation.

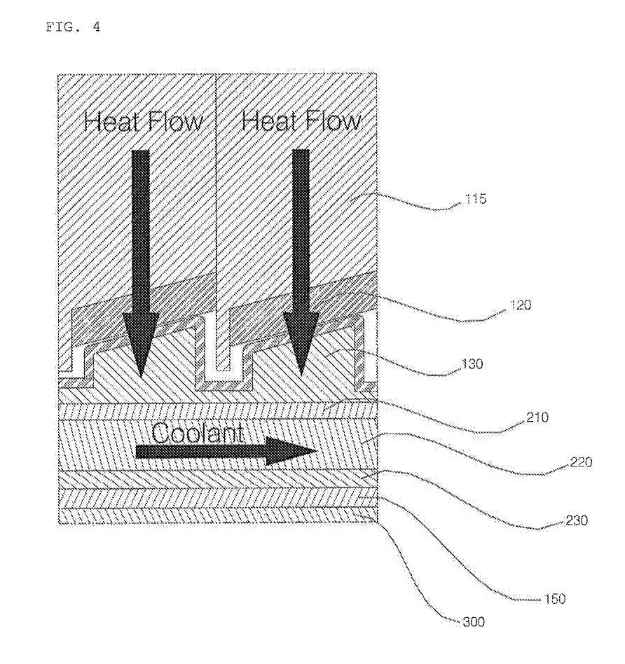

FIG. 4 is a partial cross-sectional view of a battery pack according to an implementation.

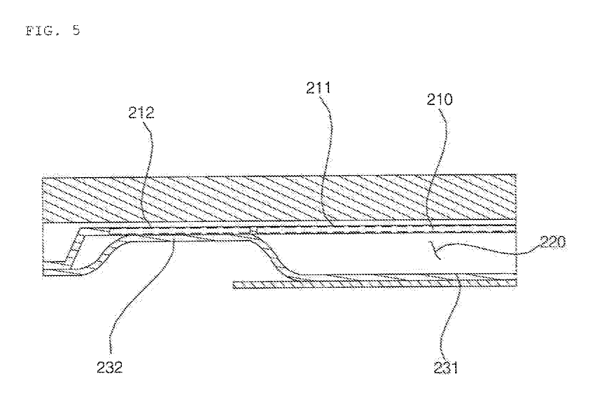

FIG. 5 is a diagram for explanation of a configuration of a thermal management system according to an implementation. FIG. 5 is an enlarged view of a portion B shown in FIG. 3.

Referring to the drawings, the thermal management system 200 may include an upper plate 210 and a lower plate 230. The upper and lower plates 210 and 230 may be separate components, or may be different portions of a single component.

The upper plate 210 may be disposed below the battery module 110.

The upper plate 210 may be in the form of a plate. The upper plate 210 may be laid with large surfaces facing up and down.

When viewed from top to bottom, the upper plate 210 may have a rectangular shape.

For convenience in heat exchange with the battery module 110, the upper plate 210 may be formed of a material having excellent thermal conductivity.

The upper plate 210 may be formed of a steel material.

For example, the upper plate 210 may be formed of a steel material having a corrosion protection layer. The corrosion protection layer may include a paint layer that is formed by painting a specific color. Alternatively, the corrosion protection layer may include a coating layer that is formed by coating a specific material for the purpose of protection from a foreign substance.

The upper plate 210 may support the battery module 110. To this end, the upper plate 210 may be formed of a high-rigid material. For example, the upper plate 210 may be formed of a steel material.

The upper plate 210 may be disposed in contact with the battery module 110. For example, the upper plate 210 may be disposed in contact with the batty cell stack 115 of the battery module 110. For example, the upper plate 210 may be disposed in contact with the thermal pad 120 of the battery module 110. For example, the upper plate 210 may be disposed in contact with the cartridge 130 of the battery module 110.

The upper plate 210 may function as a lower housing of the battery module 110. For example, the upper plate 210 may be coupled to a lateral housing of the battery module 110 and thus function as a housing of the battery module 110.

The upper plate 210 may be coupled to the lower plate 230 and therefore form a coolant passage 220 through which coolant circulates. For example, the upper and lower plates 210 and 230 may be separate components that are bonded together, or may be upper and lower portions of a single component shaped to form the passage 220. In either scenario, the upper and lower plates 210 and 230 together form the coolant passage 220 through which coolant circulates.

In some implementations, the upper plate 210 may be bonded to the lower plate 230.

For example, the upper plate 210 may be divided into a non-bonding region 211 and a bonding region 212.

The non-bonding region 211 may be a region facing a passage portion 231 of the lower plate 230.

The non-bonding region 211 may have a shape corresponding to the passage portion 231. For example, the non-bonding region 211 may have a groove in a portion facing the passage portion 231, the groove which is in a shape corresponding to the passage part 231.

The bonding region 212 may be a region facing a bonding portion 232 of the lower plate 230.

The bonding region 212 may be a region to be coupled to the bonding portion 232 by various techniques. For example, in some implementations, the bonding may be implemented with an adhesive 225. As another example, in some implementations, the bonding may be implemented by any suitable layer or insert that prevents leakage of the coolant flowing between the upper and lower plates from escaping to an outside of the pair of plates.

As the bonding region 212 of the upper plate 210 and the bonding portion 232 of the lower plate 230 are coupled to each other, the non-bonding region 211 of the upper plate 210 and the passage portion 231 of the lower plate 230 may form a specific space that extends in a horizontal direction. The space is defined as the coolant passage 220.

The upper plate 210 may include a protruding portion.

The protruding portion may be formed in the bonding region 212. The protruding portion may protrude from the bonding region 212 toward the bonding portion 232 to double-prevent leakage of the adhesive 225.

In some implementations, the upper plate 210 may have a thickness that is greater than a thickness of the lower plate 230. Such implementations may, for example, allow the lower plate 230 to break apart more easily when a physical impact or shock is applied to the battery pack, thus releasing a liquid coolant to an outside of the battery pack rather than inside towards the battery modules. For example, in some implementations, the lower plate 230 may have a particular portion or particular area that has a thickness smaller than a thickness of the upper plate 210, and this portion or area may be configured to break more easily than the upper plate 210.

The upper plate 210 may be coated with a rustproofing material. For example, the bonding region 211 of the upper plate 210 may be coated with a rustproofing material.

To prevent oxidation, the upper plate 210 may be coated with a specific paint material.

The lower plate 230 may be coupled to the upper plate 210 to form the coolant passage 220 in which coolant circulates. Specifically, the lower plate 230 may be bonded to the upper plate 210 to form a passage in which coolant circulates.

The lower plate 230 may be in the form of a plate. The lower plate 230 may be laid with large surfaces facing up and down.

When viewed from top to bottom, the lower plate 230 may have a rectangular shape.

The lower plate 230 may be formed of a steel material.

For example, the lower plate 230 may be formed of a steel material having a corrosion protection layer. The corrosion protection layer may include a paint layer that is formed by painting a specific color. Alternatively, for the protection from a foreign substance, the corrosion protection layer may include a coating layer that is formed by coating a specific material.

Since the lower plate 230 is coupled to the upper plate 210, corrosion may occur between the lower plate 230 and the upper plate 210 in the case where the lower plate 230 is formed of a material different from that of the upper plate 210.

As the lower plate 230 is formed of the same material as that of the upper plate 210, corrosion may be prevented.

If the lower plate 230 and the upper plate 210 are welded to each other, the corrosion protection layer may be damaged and therefore corrosion may occur.

If the lower plate 230 and the upper plate 210 are bonded to each other, corrosion may be prevented.

The lower plate 230 and the upper plate 210 may have a different thermal conductivity. Specifically, the lower plate 230 may have a thermal conductivity lower than that of the upper plate 210.

As the lower plate 230 has a thermal conductivity lower than that of the upper plate 210, it is possible to block heat which can possibly flow into the battery pack 100 from the outside. As a result, it is possible to prevent external heat from increasing temperature of the coolant.

The lower plate 230 may be thinner than the upper plate 210.

As the lower plate 230 is thinner than the upper plate 210, the lower plate 230 may be first damaged by an impact and it may lead to an artificial discharge of the coolant. Due to the discharge of the coolant, it is possible to prevent damage to the battery module 110 by the coolant.

The lower plate 230 may include the passage portion 231 and the bonding portion 232.

The passage portion 231 secures a space in which the coolant passage 220 is formed. For example, the passage portion 231 may be defined as a groove which extends inside the lower plate 230 in a horizontal direction. When the lower plate 230 is viewed from top to bottom, the passage portion 231 may have a passage shape.

In the case where the lower plate 230 and the upper plate 210 is not coupled together, the passage portion 231 may be in the shape of a groove which extends in a horizontal direction with an open top.

When the lower plate 230 and the upper plate 210 are coupled together, the top of the passage portion 231 is covered by the upper plate 210 to thereby form the coolant passage 220. For example, when the bonding region 212 of the upper plate 210 and the bonding portion 232 of the lower plate 230 are coupled together, the passage portion 231 may form the coolant passage 220 along with the non-bonding region 211 of the upper plate 210.

In some implementations, the passage portion 231 may be thinner than the bonding portion 231. As the passage portion 231 is thinner than the bonding portion 232, the lower plate 230 may be first damaged by an impact and it may lead to an artificial discharge of coolant. Due to the discharge of the coolant, it is possible to prevent damage to the battery module 110 by the coolant.

The bonding portion 232 may be bonded to the upper plate 210.

The bonding portion 232 may be coupled to the bonding region 212 of the lower plate 230 by the adhesive 225.

At least part of the bonding portion 232 may face the lower plate 230 with the adhesive 225 therebetween.

The bonding portion 232 may include a blocking portion. The blocking portion may have a plurality of projection structures protruding toward the upper plate 210. The blocking portion accommodates an adhesive between the plurality of projection structures so as to prevent leakage of the adhesive.

At least part of the bonding portion 232 may support the battery module 110. While the bonding portion 232 is bonded to the upper plate 310, at least part of the bonding portion 232 may support the battery module 110.

The lower plate 230 may be coated with a rustproofing material. For example, the passage portion 231 of the lower plate 230 may be coated with a rustproofing material.

For the purpose of oxidation, the lower plate 230 may be coated with a specific paint material.

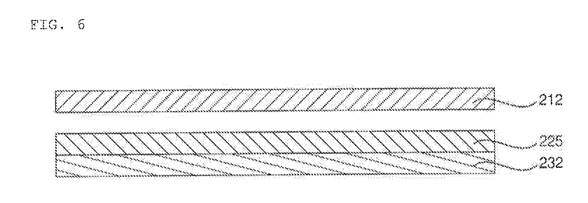

FIG. 6 is a diagram for explanation of bonding between an upper plate and a lower plate according to an implementation.

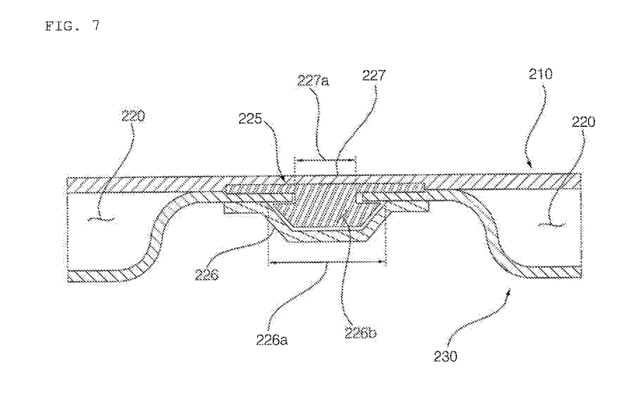

FIG. 7 is a diagram for explanation of an opening portion and a seal cap according to an implementation.

In scenarios where the upper plate 210 and the lower plate 230 are separate components formed of a steel material, the upper plate 210 and the lower plate 230 cannot be coupled together by brazing.

When coupled together by brazing, the coating or painting of the upper plate 210 and the lower plate 230 may be peeled off. As a result, oxidation due to the coolant may occur on the upper plate 210 and the lower plate 230.

For the purpose of such oxidation, as illustrated in FIG. 6, the upper plate 210 and the lower plate 230 may be bonded together by the adhesive 225.

For example, the bottom of the upper plate 210 and the top of the lower plate 230 may be coupled together by the adhesive 225.

For example, the bonding region 212 of the upper plate 210 and the bonding portion 232 of the lower plate 230 may be disposed to face each other. The bonding region 212 and the bonding portion 232 may be coupled together by the adhesive 225.

As the bonding region 212 and the bonding portion 232 are bonded, a space defined as the coolant passage 220 may be secured by the non-bonding region 211 and the passage portion 231.

In some implementations, the battery pack 100 may include one or more location pins. The adhesive 225 may be applied with the relative locations of the upper plate 210 and the lower plate 230 being using the location pins.

As illustrated in FIG. 7, the bonding portion 232 may include an opening portion 227. The opening portion 227 may allow the adhesive 225 to flow downward.

The opening portion 227 may have an opening shape in the bonding portion 232. Through the opening shape, the opening portion 227 may allow the adhesive 225 to flow downward.

The bonding portion 232 may further include a seal cap 226.

The seal cap 226 may be disposed below the opening portion 227.

The seal cap 226 may form a space in which the adhesive 225 flows through the opening portion 227 is accommodated.

The seal cap 226 may have a basket shape with an open top. The seal cap 226 may be coupled to the bottom of the lower plate 230, in which the opening portion 227 is formed. As the seal cap 226 is coupled to the bottom of the lower plate 230, an adhesive accommodation space 226b with the top having an opening may be formed.

If the upper plate 210 and the lower plate 230 are coupled together with a sufficient amount of the adhesive 225 being applied to the bonding region 212 or the bonding portion 232, the adhesive 225 may be accommodated in the adhesive accommodation space 226b through the opening portion 227. Due to this structure, it is possible to ensure a stronger coupling between the upper plate 210 and the lower plate 230.

In some implementations, an outer diameter 226a of the seal cap 226 may be greater than a diameter 227a of the opening portion 227. Due to this structure, it is possible to prevent leakage of the adhesive 225 to the outside of the seal cap 226.

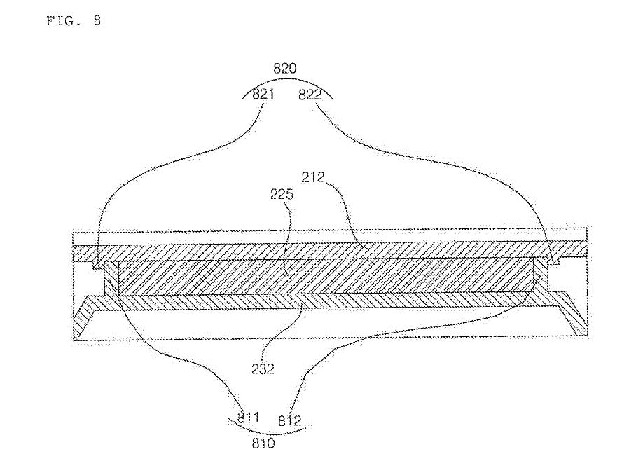

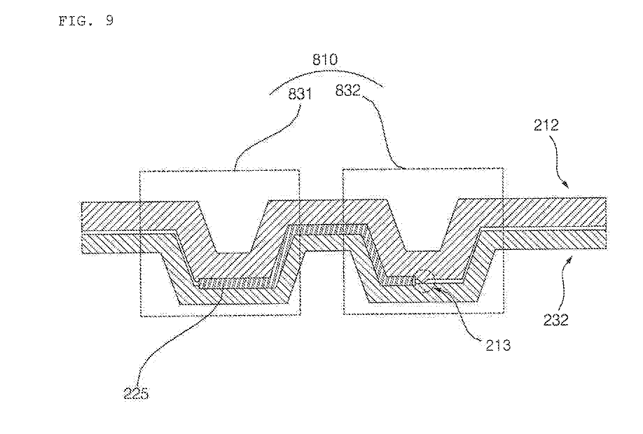

FIGS. 8 and 9 are diagrams for explanation of a blocking portion and a protrusion according to an implementation.

FIGS. 8 and 9 are enlarged views of the bonding region 212 and the bonding portion 232 bonded together by the adhesive 225.

Referring to FIG. 8, the bonding portion 232 may include a blocking portion 810. The blocking portion 810 may protrude toward the upper plate 210 to block leakage of an adhesive.

The blocking portion 810 may include a plurality of projections 811 and 812.

The plurality of projections 811 and 812 may extend in a horizontal direction while protruding toward the upper plate 210.

A space between the plurality of projections 811 and 812 may be filled with an adhesive 225.

For example, the blocking portion 810 may include a first projection 811 and a second projection 812.

The first projection 811 may be formed at one end of the bonding portion 232. The first projection 811 may extend in a horizontal direction while protruding toward the bonding region 212.

The second projection 812 may be formed at the other end of the bonding portion 232. The second projection 812 may extend in a horizontal direction while protruding toward the bonding region 212.

A space between the first projection 811 and the second projection 812 may be filled with the adhesive 225.

Even in the case where the upper plate 210 and the lower plate 230 are pressed together, the adhesive 225 may be blocked by the first projection 811 and the second projection 812 and therefore it cannot reach the passage portion 231.

The upper plate 210 may include a protruding portion 820. The protruding portion 820 may be formed in the bonding region 212. The protruding portion 820 may extend in a horizontal direction while protruding toward the lower plate 230.

The protruding portion 820 may be disposed close to the plurality of projections 811 and 812. For example, the protruding portion 820 may be disposed such that one side surface thereof comes into contact with the plurality of projections 811 and 812.

For example, the protruding portion 820 may include a first protruding portion 821 and a second protruding portion 822.

The first protruding portion 821 may be disposed such that one side surface thereof comes into contact with the first projection 811. The second protruding portion 822 may be disposed such that one side surface thereof comes into contact with the second projection 812.

The protruding portion 820 may further help prevent leakage of the adhesive 225 to the outside of the bonding portion 232.

In some implementations, the bonding region 212 may include a blocking portion, and the bonding portion 232 may include a protruding portion.

In this case, the blocking portion may include a plurality of protrusions that extends in the horizontal direction while protruding toward the lower plate 230. A space between the plurality of protrusions may be filled with an adhesive.

In this case, the protruding portion may extend in the horizontal direction while protruding toward the upper plate 230. The protruding portion may be disposed such that one side surface thereof comes into contact with the blocking portion.

Referring to FIG. 9, the bonding portion 232 may include a blocking portion 810. The blocking portion 810 may include a concave-convex part 831, 832 that consists of a plurality of protrusions and a plurality of grooves.

The bonding region 212 may include a concave-convex part that consists of a plurality of protrusions and a plurality of grooves.

The concave-convex part of the bonding portion 232 and the concave-convex part of the bonding region 212 may be engaged with each other. The concave-convex part of the bonding portion 232 and the concave-convex part of the bonding region 212 may be engaged with each other. Specifically, each groove in the concave-convex part of the bonding portion 232 and each protrusion in the concave-convex part of the bonding region 212 may be formed to correspond to each other. In addition, each protrusion in the concave-convex part of the bonding portion 232 and each groove in the concave-convex part of the bonding region 212 may be formed to correspond to each other.

In this case, the concave-convex part of the bonding portion 232 and the concave-convex part of the bonding region 212 are bonded together by the adhesive 225, and therefore, the upper plate 210 and the lower plate 230 may be coupled even stronger.

A protruding portion 213 may be formed in the concave-convex part of the bonding region 212. The protruding portion 213 may protrude toward the lower plate 230. When the concave-convex part of the bonding portion 232 and the concave-convex part of the bonding region 212 are engaged with each other, the protruding portion 213 may block leakage of the adhesive 225 to the passage portion 231.

A protruding portion may be formed in the concave-convex part of the bonding portion 232. The protruding portion may protrude toward the upper plate 210. The protruding portion may block leakage of the adhesive 225 to the passage portion 231, when the concave-convex part of the bonding part 232 and the concave-convex part of the bonding region are engaged with each other.

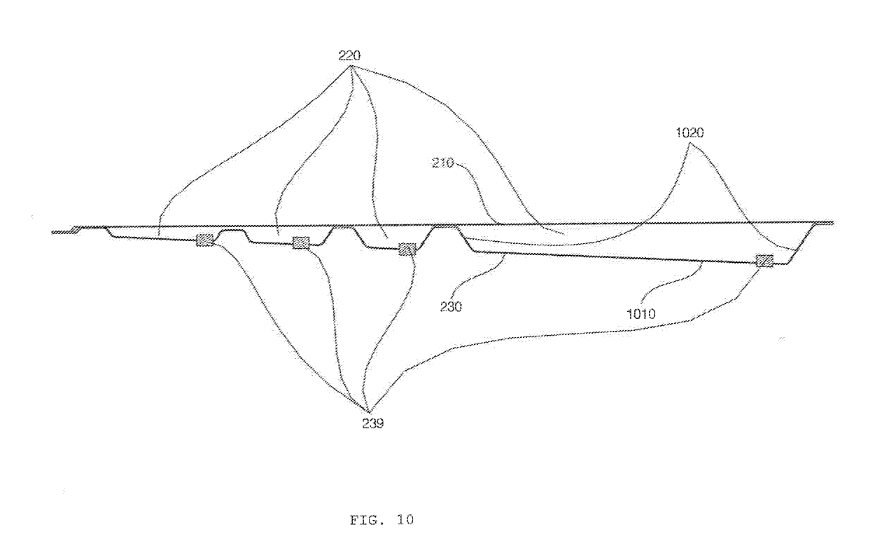

FIG. 10 is a diagram for explanation of a passage portion according to an implementation.

Referring to FIG. 10, the passage portion 231 may include a bottom surface 1010 and a side surface 1020.

The bottom surface 1010 may be a surface facing the upper plate 210.

The bottom surface 1010 of the passage portion 231 may be formed to have at a predetermined gradient in a first direction with respect to the upper plate 210. The first direction may be forward or backward. Alternatively, the first direction may be leftward or rightward.

The passage portion 231 may include a coolant discharge hole 239 which is formed at the bottom surface 1010 and whose opening and closing is controlled by an electrical signal.

When an impact occurs, the discharge hole 239 may be opened by an electrical signal which is provided by at least one control device included in a vehicle. In this case, the coolant may be discharged by the bottom surface 1010, formed at a gradient, through the discharge hole 239. As a result, coolant cannot flow into the battery module 110, and therefore, it is possible to prevent damage to the battery by the coolant.

The side surface 1020 may extend from the bottom surface 1010 to the bonding region 232.

In some implementations, the coolant passage 220 may include a plurality of passages. The passage portion 231 may include a passage that defines the plurality of respective passages. Respective bottom surfaces of the plurality of passages may include the coolant discharge hole 239.

If there is a plurality of discharge holes 239, coolant can be quickly discharged by an impact.

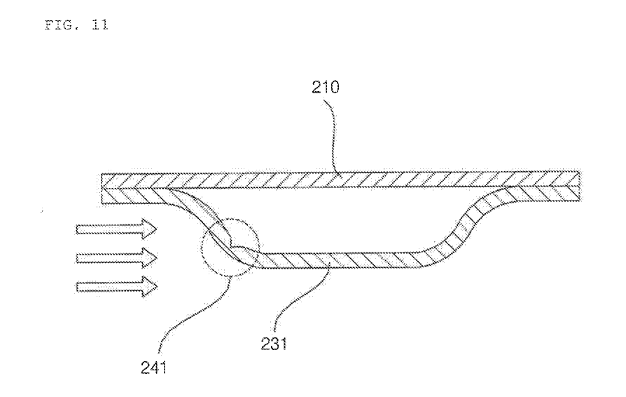

FIGS. 11 to 13 are diagrams for explanation of a notch portion according to an implementation.

Referring to FIG. 11, the passage portion 231 may include a first notch portion 241.

The first notch portion 241 may be formed on a surface facing the upper plate 210.

For example, the first notch portion 241 may be formed on an edge of the passage portion 231.

For example, the first notch portion 241 may be formed where the bottom surface 1010 and the side surface 1020 are distinguished.

Due to this location of the first notch portion 241, the first notch 241 may be easily broken by an impact.

In some implementations, a surface of the lower plate 230 facing the upper plate 210 may be defined as an inner side surface.

The first notch portion 241 may be in a structure more fragile than other portions of the passage portion 231.

For example, the first notch portion 241 may have a V shape on the inner side surface. Due to the V-shape formed on the inner side surface, the first notch portion 241 may be broken by an impact, thereby possibly causing an artificial discharge of the coolant.

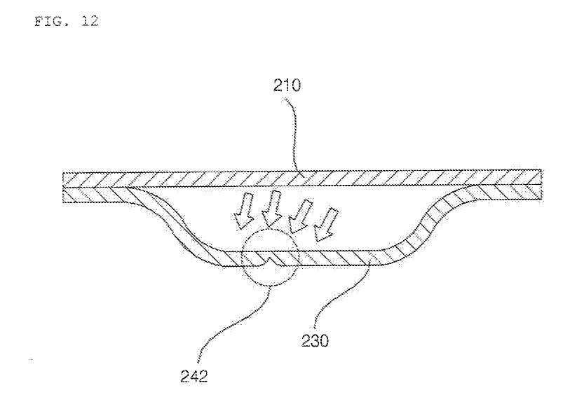

Referring to FIG. 12, the passage portion 231 may include a second notch portion 242.

The second notch portion 242 may be formed on a surface opposing the upper plate 210.

In some implementations, a surface of the lower plate 230 opposing the upper plate 210 may be defined as an outer side surface.

For example, the second notch portion 242 may be formed at the bottom surface.

Due to this location of the second notch portion 242, the second notch portion 242 may be easily broken when internal pressure is equal to or higher than a reference level.

The second notch portion 242 may be in a fragile structure, compared to other portions of the passage portion 231.

For example, the second notch portion 242 may have a V shape on the outer side surface. Due to the V shape formed on the outer side surface, the second notch portion 242 is broken in response to internal pressure equal to or higher than a reference voltage, thereby possibly causing an artificial discharge of coolant.

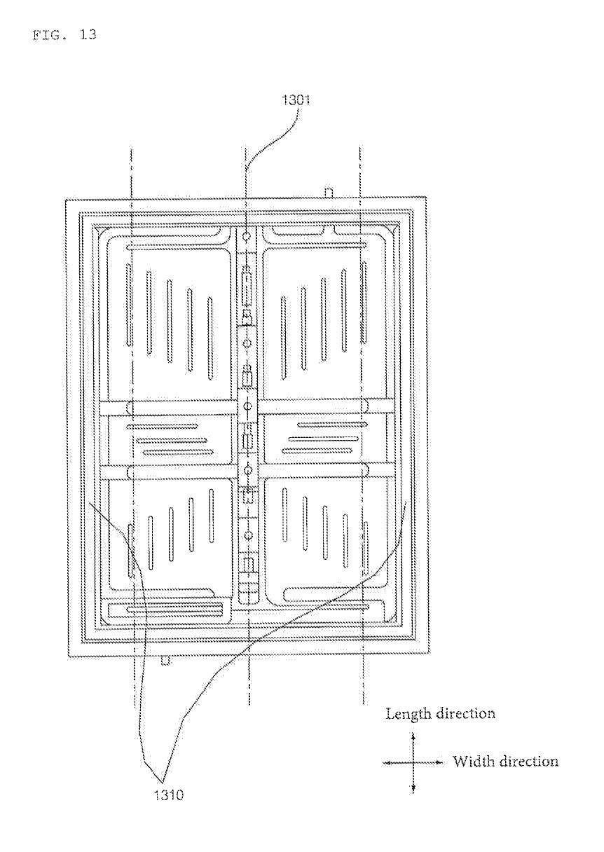

FIG. 13 shows an example of the thermal management system 200 as viewed from top to bottom.

The first notch portion 241 and the second notch portion 242 may be located in a margin area 1310 of the thermal management system 200. The margin area 1310 of the thermal management system 200 may be an area spaced apart in a width direction at a distance, which is equal to or greater than one-fifth of the entire width of the thermal management system 200, from a centerline 1301 of a longitudinal direction.

As the first notch portion 241 and the second notch portion 242 are located in the lateral margin area 1310 of the thermal management system 200, it is possible to prevent breakage of a major component of a vehicle by coolant even when the coolant is discharged.

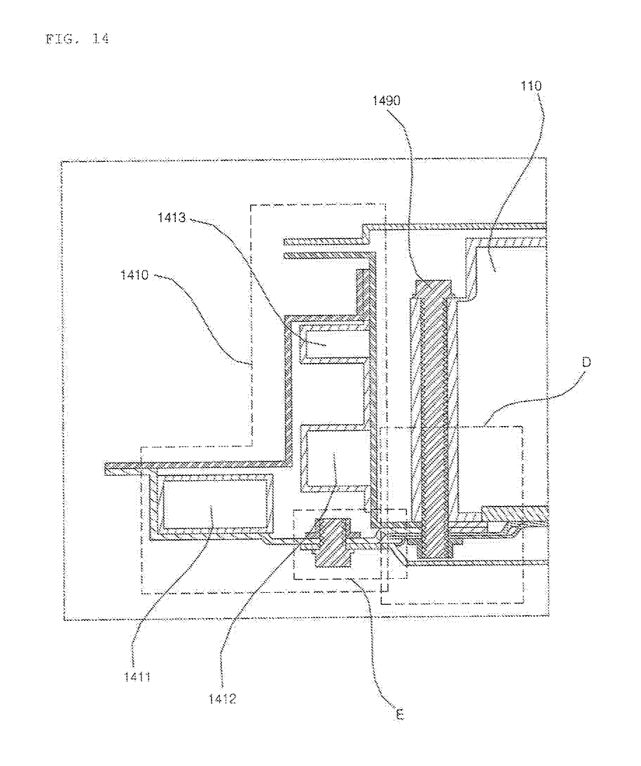

FIG. 14 is an enlarged view of a portion C shown in FIG. 3.

Referring to FIG. 14, the battery pack 100 may further include a reinforcement structure 1410.

The reinforcement structure 1410 may be formed of a steel material or an aluminum material. The reinforcement structure 1410 may be formed as a plurality of panels are coupled (e.g., welded) to one another.

The reinforcement structure 1410 may be disposed outside the battery module 110. The reinforcement structure 1410 may have one or more closed space 1411, 1412, and 1413 therein.

When a vehicle collides with an external object, the closed spaces 1411, 1412, and 1413 may absorb impact of the collision which could be otherwise transferred to the battery module 110 and the thermal management system 200.

In some implementations, the closed spaces 1411, 1412, and 1413 may be disposed above the upper late 210. In this case, when the vehicle collides with an external object, the closed spaces 1411, 1412, and 1413 may absorb the impact so as to reduce the impact which could be otherwise transferred to the battery module 110. By reducing the impact, it is possible to prevent degradation of the battery module 110, which may be caused by the impact to the battery module 110.

In some implementations, the closed spaces may be disposed below the upper plate 210. In this case, when the vehicle collides with an external object, the closed spaces may absorb the impact so as to reduce the impact which could be otherwise transferred to the thermal management system 200. By reducing the impact, it is possible to prevent leakage of coolant in the thermal management system 200.

In some implementations, the reinforcement structure 1410 may be secured to at least part of a vehicle body and the thermal management system 200.

As the reinforcement structure 1410 is secured to at least part of a vehicle body frame, a stable securing can be achieved.

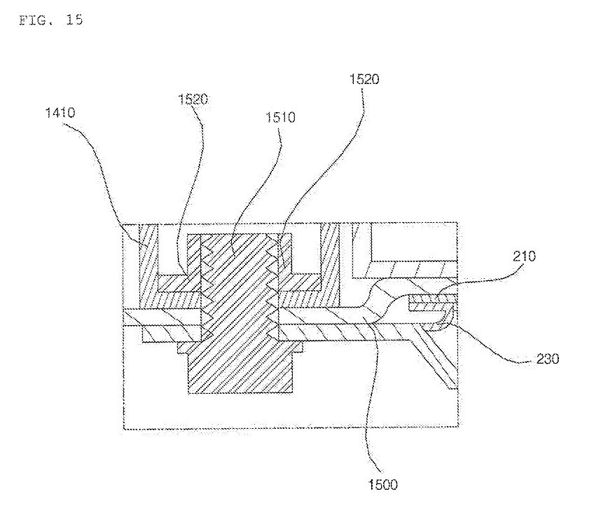

The coupling between the reinforcement structure 1410 and the thermal management system 200 will be described with reference to FIG. 15.

In some implementations, the battery module 110 and the thermal management system 200 may be secured by a long bolt 1490.

Specifically, the battery module 110 may be secured to the upper plate 210 and the lower plate 230 by the long bolt 1490.

In some implementations, the battery module 110 may be secured to the upper plate 210, the lower plate 230, and an extension plate 1500 (see FIG. 15) being stacked together.

FIG. 15 is an enlarged view of a portion E shown in FIG. 14.

Referring to FIG. 15, the battery pack 100 may further include the extension plate 1500.

The extension plate 1500 may be in contact with at least part of the lower plate 230.

The lower plate 230, the reinforcement structure 1410, and the extension plate 1500 may be bolted together while being stacked.

In some implementations, the lower plate 230, the reinforcement structure 1410, the extension plate 1500, and the outer plate 300 may be bolted together while being stacked.

As illustrated in FIG. 15, the lower plate 230 is disposed on the outer plate 300, the extension plate 1500 is disposed on the lower plate 230, and the reinforcement structure 1410 is disposed on the extension plate 1500. In this case, the lower plate 230, the reinforcement structure 1410, the extension plate 1500, and the outer plate 300 may be secured together by one bolt 1510.

In this case, the lower plate 230 may be longer than the upper plate 210 in a direction outward from the battery module 110.

Since the lower plate 230 is longer than the upper plate 210, only the lower plate 230, except the upper plate 210, is secured to the outer plate 300, the extension plate 1500, and the reinforcement structure 1400.

If a vehicle collides with an external object, only the lower plate 230 may be pushed back by impact of the collision due to the above-described structure, and therefore, coolant may be discharged to the outside. As a result, the coolant is unlikely to flow into the battery module 110.

The battery pack 100 may further include at least one fastening bracket 1520.

When the lower plate 230, the reinforcement structure 1410, the extension plate 1500, and the outer plate 200 are bolted to each other, the fastening bracket 1520 may support the bolt 1510 to achieve a stronger securing.

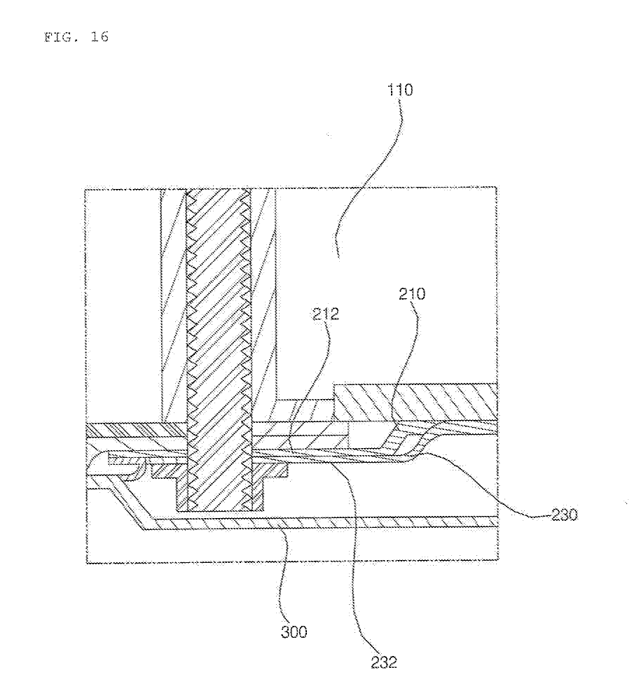

FIG. 16 is an enlarged view of a portion D shown in FIG. 14.

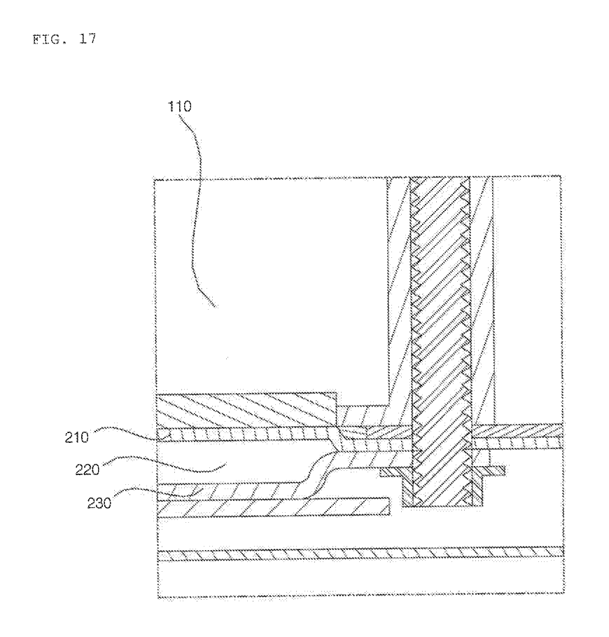

FIG. 17 is an enlarged view of a portion F shown in FIG. 3.

Referring to FIGS. 16 and 17, an end part of the battery module 110 may be located in a portion where the upper plate 210 and the lower plate 230 are coupled.

That is, at least part of the battery module 110 may vertically overlap a portion where the bonding region 212 and the bonding portion 232 are coupled.

The portion where the bonding region 212 and the bonding portion 232 are coupled may strongly support the battery module 110.

FIGS. 18 and 19 are diagrams for explanation of an outer plate according to an implementation.

Referring to FIG. 18, the outer plate 300 may be disposed below a thermal management system.

The outer plate 300 may be bolted to the upper plate 210.

When the outer plate 300 is bolted to the upper plate 210, the coupling therebetween may be supported by at least one fastening bracket 1810.

Referring to FIG. 19, the outer plate 300 may be coupled to a vehicle body 1910 using a reinforce beam 1930.

While the vehicle body 1910 and the thermal management system 200 are disposed with having the reinforce beam 1930 therebetween, the vehicle body 1910, the reinforce beam 1930, the thermal management system 200 may be coupled via a long bolt 1931 that penetrates the reinforce beam 1930.

If they are coupled via the reinforce beam 1930, the outer plate 300 may support the battery module 110 and the thermal management system 200.

The above detailed description should not be construed as being limited to the implementations set forth herein in all terms, but should be considered by way of example. The scope of the present disclosure should be determined by the reasonable interpretation of the accompanying claims and all changes in the equivalent range of the present disclosure are intended to be included in the scope of the present disclosure.

What is claimed is:

1. A battery pack for a vehicle, comprising:
at least one battery module; and
a thermal management system disposed below the at least one battery module and configured to cool the at least one battery module with a liquid coolant,
wherein the thermal management system comprises:
an upper plate that is composed of a steel material having a corrosion preventive layer on a surface thereof, and that is configured to support the at least one battery module on a first side of the upper plate; and
a lower plate that is composed of a steel material having a corrosion protection layer on a surface thereof, the lower plate arranged at a second side of the upper plate opposite the first side, and together with the upper plate forms a passage therebetween configured to provide circulation of the liquid coolant.

2. The battery pack according to claim 1, wherein the lower plate and the upper plate are bonded together to form the passage therebetween that is configured to prevent leakage of the liquid coolant to an outside of the thermal management system.

3. The battery pack according to claim 2, wherein the lower plate comprises:
a passage portion forming a passage shape through which the liquid coolant flows; and
a bonding portion that is bonded to the upper plate and that comprises a blocking portion that protrudes toward the upper plate to maintain an integrity of an adhesive that bonds the upper plate and the lower plate.

4. The battery pack according to claim 3, wherein the upper plate comprises a protruding portion that is formed in an area corresponding to the bonding portion, and that protrudes toward the bonding portion to block leakage of the adhesive that bonds the upper plate and the lower plate.

5. The battery pack according to claim 3, wherein at least part of the bonding portion is configured to support the at least one battery module.

6. The battery pack according to claim 3, wherein the bonding portion comprises:
an opening portion configured to allow leakage of an adhesive that bonds the upper plate and the lower plate; and
a seal cap disposed below the opening portion to form a space for accommodating a leaked adhesive.

7. The battery pack according to claim 3, wherein a bottom surface of the passage portion is formed to have a first gradient in a first direction with respect to the upper plate.

8. The battery pack according to claim 7, wherein the passage portion comprises a coolant discharge hole which is formed at the bottom surface, and that is configured to open and close in response to an electrical signal.

9. The battery pack according to claim 7, wherein the passage portion comprises a first notch portion formed on a surface facing the upper plate.

10. The battery pack according to claim 7, wherein the passage portion comprises a second notch portion formed on a surface opposing the upper plate.

11. The battery pack according to claim 1, wherein the lower plate has a thickness that is less than a thickness of the upper plate.

12. The battery pack according to claim 1, further comprising:
a reinforcement structure that is formed outside the at least one battery module, and which has one or more closed spaces therein.

13. The battery pack according to claim 12, further comprising:
an extension plate in contact with at least part of the lower plate,
wherein the lower plate is bolted to the reinforcement structure and the extension plate.

14. The battery pack according to claim 13, wherein the lower plate has a length that is greater than a length of the upper plate in a direction outward from the at least one battery module.

15. The battery pack according to claim 12, wherein the reinforcement structure is configured to be secured to a body of the vehicle and to the thermal management system.

16. The battery pack according to claim 1, further comprising:
an outer plate that is disposed below the thermal management system, bolted to the upper plate, and coupled to a body of the vehicle via a reinforcement beam to thereby support the at least one battery module and the thermal management system.

17. The battery pack according to claim 1, wherein the upper plate is coupled to a lateral housing of the at least one battery module and is configured as a housing of the at least one battery module.

18. The battery pack according to claim 1, wherein the lower plate and the upper plate are configured to form the passage therebetween to maintain the circulation of the liquid coolant outside the at least one battery module.

19. The battery pack according to claim 1, wherein the thermal management system is configured to, upon physical impact on the battery pack, release at least part of the liquid coolant to an outside of the battery pack.

20. A vehicle comprising:
a plurality of wheels;
a power source configured to drive a rotation of at least one of the plurality of wheels; and
a battery pack comprising:
at least one battery module; and
a thermal management system disposed below the at least one battery module and configured to cool the at least one battery module with a liquid coolant,
wherein the thermal management system comprises:
an upper plate that is composed of a steel material having a corrosion preventive layer on a surface thereof, and that is configured to support the at least one battery module on a first side of the upper plate; and
a lower plate that is composed of a steel material having a corrosion protection layer on a surface thereof, the lower plate arranged at a second side of the upper plate opposite the first side, and together with the upper plate forms a passage therebetween configured to provide circulation of the liquid coolant.
